(19) United States
(12) Patent Application Publication
(10) Pub. No.: US 2010/0184389 A1
(43) Pub. Date: Jul. 22, 2010

(54) WIRELESS COMMUNICATION UNIT, INTEGRATED CIRCUIT AND METHOD FOR BIASING A POWER AMPLIFIER

(75) Inventors: Frederic Fraysse, Villeneuve-Tolosane (FR); Gilles Montoriol, Tournefeuille (FR); Didier Salle, Toulouse (FR)

Correspondence Address: LARSON NEWMAN & ABEL, LLP, 5914 WEST COURTYARD DRIVE, SUITE 200, AUSTIN, TX, 78730, US

(73) Assignee: FREESCALE SEMICONDUCTOR, INC., Austin, TX (US)

(21) Appl. No.: 12/063,425

(22) PCT Filed: Aug. 9, 2005
(86) PCT No.: PCT/EP2005/009963

§ 371 Date: Apr. 5, 2010

(51) Int. Cl. H04B 1/02

(52) U.S. Cl. 455/108

(57) ABSTRACT

A wireless communication unit (100) comprises a transmitter (120) arranged to transmit an envelope modulated signal. The transmitter (120) comprises a radio frequency power amplifier (124) operably coupled to a logarithmic detector (210, 310) and a bias control circuit (126) arranged to set a direct current bias level of the radio frequency power amplifier (124) via a bias signal. The logarithmic detector (210, 310) is arranged to detect the envelope modulated signal and provide the detected envelope modulated signal to the bias control circuit such that the bias signal applied to the radio frequency power amplifier (124) comprises both a direct current and a low frequency component based on the detected envelope modulated signal. In this manner, the present invention supports a tradeoff of linearity for additional efficiency, as well as providing more margin on adjacent channel power levels, whilst maintaining a good overall power added efficiency.

### FIELD OF THE INVENTION

An embodiment of the present invention relates to bias circuits for linear power amplifiers. The invention is applicable to, but not limited to, an arrangement to improve the linearity of power amplifiers suitable for EDGE/3G applications.

### BACKGROUND OF THE INVENTION

A primary focus of the present invention is the field of radio frequency (RF) and microwave amplifiers capable of use in telecommunication applications. Continuing pressure on the limited spectrum available for radio communication systems is forcing the development of spectrally-efficient linear modulation schemes. Since the signal envelopes of a number of these linear modulation schemes fluctuate, intermodulation products can be generated in the non-linear power amplifier. Specifically, in this field, there has been a significant amount of research effort focused on developing highly efficient topologies using the ‘back-off’ (linear) region of the power amplifier.

However, in order for a communication unit to transmit non-constant envelope modulation signals, the amplified signals must not be distorted. Notably, such non-constant envelope transmissions are required from communication units supporting the known EDGE/3 G communication standard. Numerous techniques are continually being proposed to further minimise the distortion introduced by the power amplifier into a non-constant envelope transmission by such wireless communication units.

US2003/0139153 A1 by R. J. McMorrow and titled “EDGE Power detector/controller” describes a circuit with a power control loop that is suitable for use with the EDGE communication standard. The circuit uses a log detector to detect an absolute power level, which is subsequently used to control the PA output power. However, the use of a logarithmic detector is solely used to control the output power.

US 2004/0174212 A1 by K. Bummam and titled “Doherty Amplifier Using Adaptive Bias Control” describes a very specific circuit with an injection circuit for a Doherty amplifier, which contains two power amplifiers. The circuit includes an envelope detector and highly complex envelope shaping circuits that are used to set a gain of a Doherty amplifier.

U.S. Pat. No. 6,785,521 B2 by A. Hadjichristos and titled “System and method for current-mode amplitude modulation” describes a circuit with a controllable current source. However, U.S. Pat. No. 6,785,521 B2 fails to explain any mechanism as to how the modulation envelope may be sensed.

There exists a need to improve the linearity of a power amplifier arrangement, and method of operation therefor, for a given current consumption or, in the converse, decrease the given current consumption to maintain a particular linearity.

### STATEMENT OF INVENTION

In accordance with aspects of the present invention, there is provided a wireless communication unit, integrated circuit and method of operation, as defined in the appended Claims.

### BRIEF DESCRIPTION OF THE DRAWINGS

Exemplary embodiments of the present invention will now be described, by way of example only, with reference to the accompanying drawings, in which:

FIG. 1 illustrates a wireless communication unit adapted in accordance with an embodiment of the present invention;

FIG. 2 illustrates a power amplifier bias circuit employing envelope injection via current, in accordance with an embodiment of the present invention;

FIG. 3 illustrates a power amplifier bias circuit employing envelope injection via voltage, in accordance with an embodiment of the present invention;

FIG. 4 illustrates a logarithmic detector and voltage-to-current (V2I) converter arrangement in accordance with an embodiment of the present invention;

FIG. 5 illustrates graphically the V2I converter gain with respect to output current and the envelope modulation in the V2I converter according to an embodiment of the present invention; and

FIG. 6 illustrates a flowchart of the power amplifier biasing process according to an embodiment of the present invention.

### DESCRIPTION OF EMBODIMENTS

An embodiment of the present invention will be described in terms of a wireless communication unit capable of operation in accordance with the EDGE or 3G standards, as defined by the third generation partnership project (3GPP). However, it will be appreciated by a skilled artisan that the embodiments herein described may be embodied in any type of radio frequency amplifier arrangement, and biasing circuit therefor, where improving the linearity and efficiency of the power amplifier stage is important.

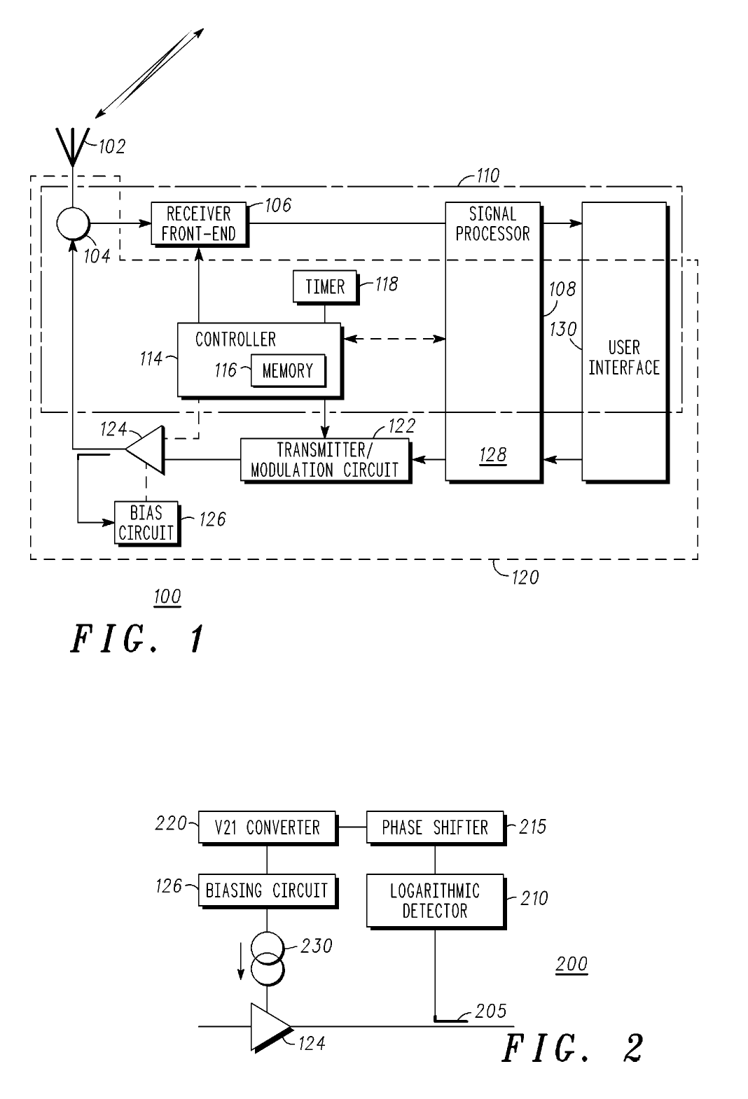

Referring now to FIG. 1, there is shown a block diagram of a wireless communication unit 100, adapted to support embodiments of the present invention. For example, the wireless communication unit 100 comprises an antenna 102, preferably coupled to a duplex filter or antenna switch 104 that provides isolation between a receiver chain 110 and a transmitter chain 120 within the wireless communication unit 100. As also known in the art, the receiver chain 110 typically includes a receiver front-end circuit 106 (effectively providing reception, filtering and intermediate or base-band frequency conversion). The receiver front-end circuit 106 is serially coupled to a signal processing function 108, typically implemented as a digital signal processor (DSP). An output from the signal processing function 108 is provided to a suitable user interface, which preferably comprises an output device 110, such as a speaker and/or display, and an input device, such as a microphone and/or keypad.

The user interface 130 is operably coupled to a memory unit 116 and a timer 118 via the signal processing function 108 and/or a controller 114. The controller 114 is also coupled to the receiver front-end circuit 106 and the signal processing function 108. The controller 114 may therefore receive bit error rate (BER) or frame error rate (FER) data from recovered information. The controller 114 is coupled to the memory device 116 for storing operating regimes, such as decoding/encoding functions and the like. A timer 118 is typically coupled to the controller 114 to control the timing of operations (transmission or reception of time-dependent signals) within the wireless communication unit 100.

As regards the transmit chain, the input device is coupled to a transmitter/modulation circuit 122 via the signal processing function 108 (or function 128 if the transmit and receive portions of the signal processor were distinctly implemented). Thereafter, the transmit signal is passed through a power amplifier 124 to be radiated from the antenna 102. The transmitter/modulation circuit 122 and the power amplifier 124 are operationally responsive to the controller 114, with an output from the power amplifier 124 coupled to the duplex filter or antenna switch 104. The transmitter/modulation circuitry 122 and receiver front-end circuitry 106 comprise frequency up-conversion and frequency down-conversion functions (not shown).

In summary, in accordance with an embodiment of the present invention, the power amplifier circuit 124, and particularly its associated bias circuit 126 has been adapted to provide a new envelope modulated-injection signal to apply to, and by, the bias circuit of the power amplifier in order to improve the power amplifier linearity. Injecting modulation into the biasing of the PA with the correct phase and amplitude reduces the output distortion signal at RF because the injected signal is folded around the RF and its harmonics by the non-linearity of the PA.

Notably, a voltage of the envelope modulated signal is ‘sensed’ by a logarithmic detector. In this context, the term ‘sensed’ encompasses a portion of the signal to be transmitted that is either input to the power amplifier or an amplified version output from the power amplifier.

In a first embodiment of the present invention, the detected voltage is phase shifted and is then converted into a current. This current is injected in the PA biasing circuit: via either the base/gate or the collector/drain of the RF power transistor. Thus, the envelope modulated signal is combined with the dc biasing signal that is applied by the bias control circuit to bias the RF PA.

In an alternative (second) embodiment of the present invention, the detected voltage is amplified and injected as a voltage in either the base/gate or the collector/drain of RF transistor. In this regard, an amplifier is used to ensure that the detected envelope modulated signal is applied at the correct amplitude (as well as phase, which is set by the phase shifter). The adaptation of the Power amplifier bias circuit 126 is further described below with respect to FIGS. 2 to 5.

It is within the contemplation of the present invention that the embodiments are equally applicable with any known biasing circuit, as would be appreciated by a skilled artisan.

It will be appreciated that the various components and circuits within the wireless communication unit 100 can be arranged in any suitable functional topology, in order to utilise the embodiments of the present invention. Furthermore, the various components within the wireless communication unit 100 can be realised in discrete or integrated component form, with an ultimate structure therefore being merely an application-specific selection.

Advantageously, the first and second embodiments of the present invention improve the linearity of the power amplifier 124, particularly for EDGE/3G applications that use envelope modulation.

Referring now to FIG. 2, and according to the first embodiment of the present invention, an envelope modulated signal is input to the radio frequency power amplifier transistor 124. An amplified envelope modulated output signal is sampled by coupler 205. The sampled and amplified envelope modulated output signal is input to a logarithmic detector 210. Notably, the logarithmic detector 210 is arranged to ‘sense’ a voltage level of the output modulation envelope. The logarithmic detector produces a voltage that is proportional to the modulation signal with a limited bandwidth that must be higher than the modulation bandwidth but lower than the RF. The detected voltage is then applied to phase-shifter 215, to ensure that the injected modulation signal is of the correct phase and then converted from a voltage level to a current level in a voltage to current converter 220. The simplest form of V2I circuit is, of course, a resistor. Notably, this current is injected into the power amplifier biasing circuit 126. The injection of the bias signal is preferably performed either via the base/gate port or the collector/drain port of the radio frequency (RF) power amplifier transistor.

Referring now to FIG. 3, and in accordance with a second embodiment of the present invention, an envelope modulated signal is input to the radio frequency power amplifier transistor 124. An amplified envelope modulated output signal is again sampled by coupler 305. The sampled amplified envelope modulated output signal is input to a logarithmic detector 310. Notably, the logarithmic detector 310 is arranged to ‘sense’ the output modulation envelope. The detected voltage is then applied to phase-shifter 215 and then amplified in RF amplifier 320. Notably, this voltage is then applied in the power amplifier biasing circuit 126. The injection of the bias signal is preferably performed either via the base/gate port or the collector/drain port of the radio frequency (RF) power amplifier transistor.

In this manner, the first and second embodiments of the present invention provide a new envelope-injection circuit that improves power amplifier linearity. In particular, the first and second embodiments of the present invention propose using the logarithmic detector in a novel manner; that is to detect the envelope modulation of the RF PA output (or input) signal rather than the amplified RF power level.

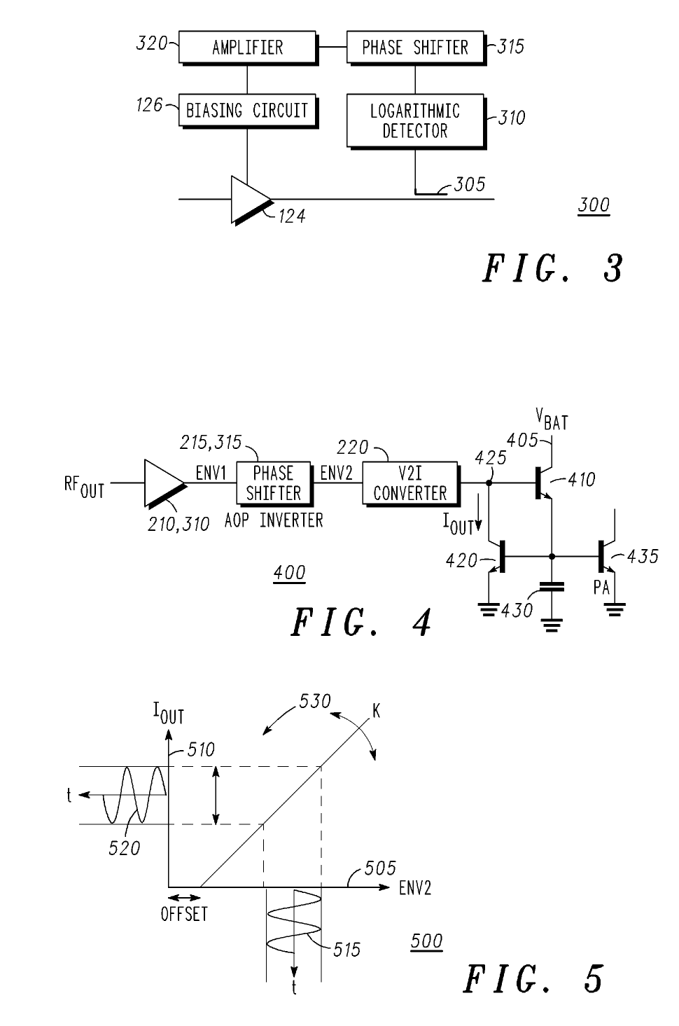

Referring now to FIG. 4, a logarithmic detector and V2I converter arrangement 400 is illustrated in accordance with an embodiment of the present invention. As mentioned above, a sample of the RF input, or amplified output, envelope-modulated signal is input to a logarithmic detector 210, 310. The use of the logarithmic detector 210, 310 removes the need to adjust the injection loop gain of the amplifier across all input RF power levels, due to constant gain of the logarithmic detector 210, 310 for modulation versus power. This is true for a small modulation index.

The sensed envelope modulation signal is then input to a phase shifter, where the envelope modulation signal is phase shifted and thereafter input, say (according to the first embodiment), to a voltage to current (V2I) converter 220.

The output of the V2I converter 220 is input to a direct current (DC) biasing circuit configured to supply a bias current 440 to the PA. Here, the DC input voltage 425 is summed with the V2I converter output. The V2I current is passed to a first reference transistor 420, whose base port is operably coupled to the base of the PA 435 to force the PA base voltage. A reference voltage, such as a battery voltage 405 is provided as a collector voltage to a second transistor 410, which is supplying the base current for the PA 435.

The summed current, i.e. the dc plus modulation current is provided to the collector of the first reference transistor. It is envisaged that this summation may be performed at any suitable location, such as before the V2I or immediately after the V2I or employing two V2I elements and combining their output.

In this manner, the V2I, in contrast to known uses of the V2I function, is now arranged to provide a bias current to the PA. Furthermore, the logarithmic detector 210, 310 can also be utilised within the loop that controls the output power delivered by the PA in the known manner.

In an enhanced embodiment of the present invention, the use of a logarithmic detector and V2I converter arrangement in the above manner is only used periodically or intermittently (any time desired), say during an Edge burst transition, i.e. during a ramp-up and/or a ramp-down process.

This invention can also be used in the known 3G (WCDMA or other) standard. In this regard, it is envisaged that the log detector can be used to control the PA output power during the periods where the modulation is constant (advantageously utilising such period of times) and used for re-injection during the real signal transmitting periods. In this enhanced embodiment, once a transmission burst is underway, the delivered output power is held constant, and the logarithmic detector, phase shifter and V2I converter arrangement is no longer used to bias the power amplifier. In this regard, the power-control loop is periodically opened and closed in alignment with the EDGE burst. In Edge mode, the log detector is used to control the PA output power in a closed-loop manner, during ramp-up and ramp down of the burst. During the burst itself, the output-power control loop is opened and the log detector is used for the re-injection process. Outside of the ramp-up or ramp-down process, it is envisaged that the V2I converter reverts to its normal operation.

Thus, the logarithmic detector senses the PA envelope modulation signal and re-injects this modulation signal as a low-frequency AC signal (without changing the nominal DC biasing value) into the PA biasing circuit in a dynamic process. In this manner, the logarithmic detector in the first and second embodiments of the present invention has been used to improve the linearity of the radio frequency power amplifier by ‘re-injecting’ an envelope modulation signal in the biasing control circuit, in contrast to its known use of detecting a PA output power level, and this detected level then being processed to determine an optimal bias setting of the bias control circuit.

Referring now to FIG. 5, a graph 500 illustrates the V2I converter gain 530 with respect to output current 510 and envelope modulation 505 in the V2I converter according to an embodiment of the present invention. The graph illustrates a dc component of the current plus modulation 520 and input dc modulation at the V2I 515, with a dc offset.

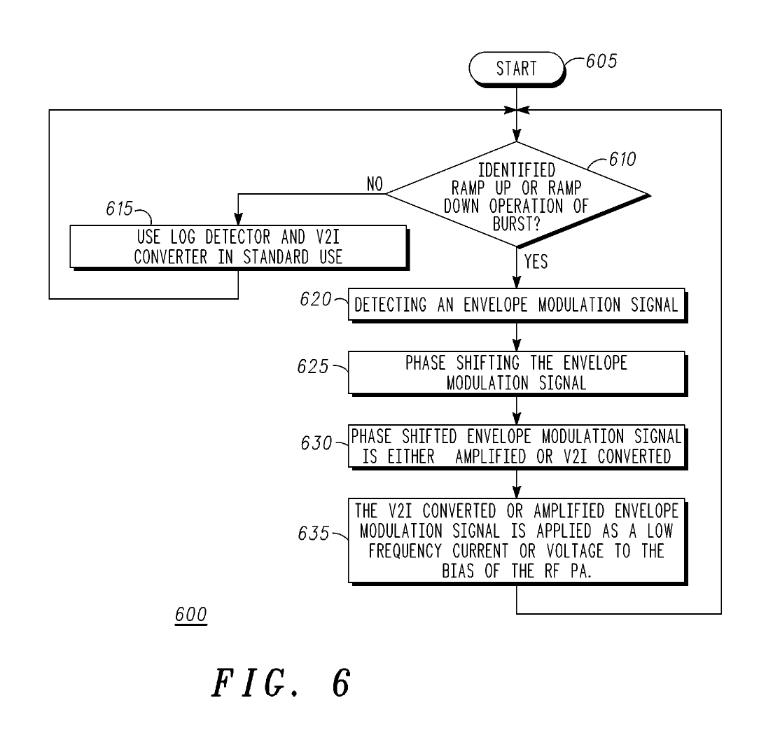

Referring now to FIG. 6, a flowchart 600 illustrates a method of biasing a power amplifier circuit. The method commences in step 605 with identifying whether a ramp-up or ramp-down operation in a burst, is occurring, as shown in step 610. If it is not part of a ramp-up or ramp-down operation, in step 610, the logarithmic detector and the V2I converter are operated in a standard manner, as shown in step 615. If it is determined that a ramp-up or ramp-down operation of the burst is being performed, in step 610, the process moves to detecting an envelope modulation signal input to, or output from, a radio frequency power amplifier (RF PA), as shown in step 620. The detected envelope modulation signal is then phase shifted in step 625.

The phase shifted envelope modulation signal is then either amplified (if a voltage bias mechanism is used) or V2I converted (if a current bias mechanism is used), as shown in step 630. Thereafter, the V2I converted or amplified envelope modulation signal is applied as a low-frequency current or voltage signal to the bias control circuit of the RF PA, as in step 635.

Advantageously, the proposed power amplifier bias circuit is self-adjusting for all output power levels, due to the intrinsic properties of the logarithmic detector. The log detector provides constant modulation envelope results, whatever the PA output power, for small modulation indexes (which is the case for Edge and 3G modulation standards), therefore providing a constant gain (versus output power) for the re-injection process.

A skilled artisan will appreciate that in other applications, alternative functions/circuits/devices and/or other techniques may be used that still apply the embodiments hereinbefore described.

It will be understood that the improved wireless communication unit, integrated circuit to provide bias control of a radio frequency power amplifier, and method of operation therefor, as described above, aims to provide at least one or more of the following advantages:
(i) The logarithmic detector serves a dual purpose, in that it is capable of detecting an envelope modulation signal for re-injection into the bias signal applied to the RF PA as well as detecting a radio frequency power level;
(ii) The bias control circuit loop performance is dynamically maintained at a constant level, irrespective of the output signal. That is, no continuous adjustment of the loop gain is required;
(iii) The proposed embodiments can be integrated in a small silicon area;
(iv) The proposed embodiments make it easier to achieve the desired spectral purity to meet the 3G/Edge specification(s);
(v) It supports a trade-off of linearity for additional efficiency. Hence, it allows a reduction in current drain (therefore improving efficiency) at constant linearity, or conversely improving linearity at a given current drain;
(vi) The proposed embodiments provide more margin on adjacent channel power (ACP) levels, whilst maintaining a good overall power added efficiency (PAE); and
(vii) The proposed embodiments are applicable to any type of Power Amplifier.

In particular, it is envisaged that the aforementioned embodiments can be applied by a semiconductor manufacturer to any front-end module. Furthermore, the embodiments can be applied to any power amplifier device or bias circuit therefor. It is further envisaged that, for example, a semiconductor manufacturer may employ the embodiments in a design of a stand-alone device, or application-specific integrated circuit (ASIC) and/or any other sub-system element.

Whilst the embodiments of the present invention are described above, it is clear that one skilled in the art could readily apply variations and modifications of such embodiments that fall within the concepts described.

Thus, an improved wireless communication unit, integrated circuit to provide a bias control of a radio frequency power amplifier, and method of operation therefor have been described, wherein the aforementioned disadvantages with prior art arrangements have been substantially alleviated.

1. A wireless communication unit comprising:
a transmitter arranged to transmit an envelope modulated signal, wherein the transmitter comprises a radio frequency power amplifier operably coupled to a logarithmic detector and a bias control circuit arranged to set a direct current bias level of the radio frequency power amplifier via a bias signal;
wherein the logarithmic detector is arranged to detect the envelope modulated signal and provide the detected envelope modulated signal to the bias control circuit;
wherein the bias signal applied to the radio frequency power amplifier comprises both a direct current and a low frequency component based on the detected envelope modulated signal.

2. A wireless communication unit according to claim 1 wherein the operation of the logarithmic detector to detect the envelope modulated signal is performed intermittently or periodically.

3. A wireless communication unit according to claim 1 wherein the logarithmic detector is selectively enabled upon a burst transition, such as a ramp-up or ramp-down of the burst signal.

4. A wireless communication unit according to claim 1 wherein the logarithmic detector is operably coupled to a phase shifter arranged to phase shift the detected envelope modulated signal.

5. A wireless communication unit according to claim 1 wherein the logarithmic detector is operably coupled to a voltage to current converter arranged to convert a voltage of the detected envelope modulated signal into a current to be applied to a bias point of the radio frequency power amplifier.

6. A wireless communication unit according to claim 1 wherein the logarithmic detector is operably coupled to a voltage amplifier arranged to amplify the detected envelope modulated signal and apply the amplified voltage to a bias point of the radio frequency power amplifier.

7. A wireless communication unit according to claim 1 wherein the wireless communication unit is compliant with EDGE or 3G envelope modulated communications.

8. An integrated circuit for operably coupling to a radio frequency power amplifier and arranged to route an envelope modulated signal, wherein the integrated circuit comprises:
a logarithmic detector and a bias control circuit arranged to set a direct current bias level of the radio frequency power amplifier via a bias signal;
wherein the logarithmic detector is arranged to detect the envelope modulated signal and provide the detected envelope modulated signal to the bias control circuit;
wherein the bias signal applied to the radio frequency power amplifier comprises both a direct current and a low frequency component based on the detected envelope modulated signal.

9. An integrated circuit according to claim 8 wherein the operation of the logarithmic detector to detect the envelope modulated signal is performed intermittently or periodically.

10. An integrated circuit according to claim 8 wherein the logarithmic detector is selectively enabled upon a burst transition, such as a ramp-up or ramp-down of the burst signal.

11. An integrated circuit according to wherein the logarithmic detector is operably coupled to a phase shifter arranged to phase shift the detected envelope modulated signal.

12. An integrated circuit according to claim 8 wherein the logarithmic detector is operably coupled to a voltage to current converter arranged to convert a voltage of the detected envelope modulated signal into a current to be applied to a bias point of the radio frequency power amplifier.

13. An integrated circuit according to claim 8 wherein the logarithmic detector is operably coupled to a voltage amplifier arranged to amplify the detected envelope modulated signal and apply the amplified voltage to a bias point of the radio frequency power amplifier.

14. A method of biasing a radio frequency power amplifier operably coupled to a logarithmic detector and a bias control circuit and arranged to transmit an envelope modulated signal, the method comprising:
detecting the envelope modulated signal by the logarithmic detector; and
providing the detected envelope modulated signal to a bias control circuit;
biasing the radio frequency power amplifier with both a direct current and a low frequency component based on the detected envelope modulated signal.

15. A method according to claim 14 further comprising:
performing intermittently or periodically the step of detecting the operation of the logarithmic detector to detect the envelope modulated signal.

16. A method according to claim 14, further comprising:
selectively enabling the step of detecting by the logarithmic detector in alignment with a burst transition, such as a ramp-up or ramp-down of the burst signal.

17. A method according to claim 14, further comprising:
phase shifting the detected envelope modulated signal.

18. A method according to claim 13, further comprising: converting a voltage of the detected envelope modulated signal into a current and applying the current to a bias point of the radio frequency power amplifier.

19. A method according to claim 15, further comprising:
selectively enabling the step of detecting by the logarithmic detector in alignment with a burst transition, such as a ramp-up or ramp-down of the burst signal.

20. A method according to claim 15, further comprising:
phase shifting the detected envelope modulated signal.
